(19) United States
(12) Patent Application Publication
(10) Pub. No.: US 2003/0110211 A1
(43) Pub. Date: Jun. 12, 2003

(54) Method and system for communicating, creating and interacting with content between and among computing devices

(76) Inventor: David Jean-Philippe Danon, New York, NY (US)

Correspondence Address: Matthew W. Siegal, Stroock & Stroock & Lavan LLP, 180 Maiden Lane, New York, NY, 10038, US

(21) Appl. No.: 10/211,702

(22) Filed: Aug. 1, 2002

Related U.S. Application Data
(60) Provisional application No. 60/339,012, filed on Dec. 7, 2001.
(60) Provisional application No. 60/391,301, filed on Jun. 25, 2002.

(51) Int. Cl. G06F 15/16

(52) U.S. Cl. 709/203

(57) ABSTRACT

A system and method for communicating, creating and interacting with content between and among computing devices. A musical composition may be transmitted along with or as part of an e-mail message. An applet is provided that enables a user to play back, revise, create, and transmit musical compositions without having to download large software applications by utilizing short repeating loops of music that permit hi-fidelity sound quality without the normally required large file size. Each sender/recipient computing device has the ability to provide an audio output, and has client software that facilitates the transmission and reception of e-mail. In addition, a Shockwave, Flash, or other similar plug-in (or hardware and/or software playback logic) is also required. Special purpose software is provided on a server to facilitate communication of a musical composition via e-mail, or other techniques such as instant messaging, chat, or even voice) between and among computing devices over a network such as the Internet. In yet another embodiment, a first user may add a sound to a text message that is played back simultaneously with the recipient's reading of the text message.

### CROSS-REFERENCE TO RELATED APPLICATIONS

This application claims the benefits of U.S. Provisional Patent Application No. 60/339,012, filed on Dec. 7, 2001, and U.S. Provisional Patent Application No. 60/391,301, filed on Jun. 25, 2002. This application incorporates by reference herein the subject matter presented in each of those provisional applications.

### BACKGROUND OF THE INVENTION

One of the great advantages provided by computing devices is the ability of two or more people to communicate virtually instantaneously over great distances. One type of communication thus possible is text-only, where one person creates and transmits a text-only message to another person, or a plurality of other people, using commercially available e-mail software, for example. Text-only e-mail messages consume relatively small amounts of network bandwidth as they propagate over a network, and also consume a relatively small amount of memory or disk space on the recipient's computing device.

While the processing power of computing devices continues to increase, people increasingly desire to communicate various multi-media content alone or along with text. For example, it is now common to send a text e-mail message with attached or embedded media content. However, in order for the recipient to view, hear or display the content, a relatively large software application is typically required to be installed on the recipient's computing device. For example, for a photograph attachment to an e-mail, the recipient must have a suitable photo viewer (e.g., Microsoft Photo Editor) installed on their computing device (or installed on a network to which their computing device may connect) in order to view the photograph. That shortcoming is further exacerbated for hand-held computing devices, which are typically limited by the size and resolution of their displays, and by their available memory. Thus, certain types of computer users (e.g., workers in an office environment provided with computing devices that cannot access various type of content) and certain types of computing devices (e.g., hand-held computing devices) may not have the capacity to store a laundry list of programs needed to access various types of media content that may be sent with e-mail and the like.

As another example, there is also an increasing interest in the ability to create, revise and exchange music or other content between and among computing devices; typically over a network. For example, and using music for illustrative but non-limiting purposes, it is desirable to create a musical composition and send that composition to a recipient over a network. It is also desirable for the recipient to be able to play back the composition, revise the received composition, or create a new composition. In any case, the recipient may send the revised or new musical composition back to the original sender, and/or on to additional recipient(s). However, such communication typically requires that both the sender and recipient(s) have compatible software installed on (or available to) their respective computing devices that will enable play-back, revision, creation, and transmission of the musical composition. That software may require a significant amount of disk space on the user's computing device.

Accordingly, it is desirable to provide a method and system of communicating, creating and interacting with content between and among computing devices that overcomes the above-described and other shortcomings of the prior art.

### SUMMARY OF THE INVENTION

It is thus desirable to provide a method and system for communicating, creating and interacting with content between and among computing devices utilizing existing/universal platforms, rather than via proprietary software. It is also desirable to provide a method and system of communicating content between and among computing devices in a manner that reduces bandwidth and storage size requirements. The present invention provides those and other novel and non-obvious improvements over the prior art.

Generally speaking, in accordance with the present invention, a system and method are provided for communicating, creating and interacting with content between and among computing devices. As used herein, the term “content” refers to any information that may be communicated between two computing devices. Content may include, by way of example and not limitation, text data, numeric data, photos, videos, graphics (still and animated), audio, music, combined audio and video, streaming media (e.g., music, video, audio, combined video and audio), any combination of the foregoing, and all other types of digital or analog information that may be communicated by one computing device and received by one or more other computing devices. If web-based e-mail is used, then the client software need not be able to communicate e-mail on its own, but rather, it provides access to an online e-mail system.

In a preferred embodiment of the invention, a musical composition is transmitted along with or as part of an e-mail message. The recipient of the e-mail message can play back a musical composition, revise it, save it, create a new musical composition, load a previously saved composition, and transmit a musical composition to the original sender and/or to additional recipient(s). In a preferred embodiment of the invention, the only limitation on each sender/recipient computing device is the ability to provide an audio output (by speaker, headphone, etc.), and client software that facilitates the transmission and reception of e-mail. The elimination of the need for conventional client-based software application(s) for music play back, creation, revision, and transmission, is advantageously achieved by the present invention by transmitting with an e-mail a tag to load an applet (also referred to as a client component and described in more detail below) from a server and operable in connection with a plug-in platform or plug-in such as, for example, a Shockwave or Flash plug-in. No other client software is required.

In a preferred embodiment of the invention, functionality is added to a user's computing device by an applet or plug-in available from a web server. The applet facilitates the composition, revision, saving, retrieving, creation and transmission of a musical composition to one or more recipients. Various other functionalities provided by the applet of the present invention are described in further detail herein, with variations thereof being contemplated by and within the scope and spirit of the present invention.

An applet in accordance with the present invention is preferably operable in connection with any computing platform (including, but not restricted to, personal computers, cellular/mobile phones, personal digital assistant devices, and any other device capable of processing, inputting/outputting, and transmitting/receiving content) and allows a user to create musical compositions in the various manners described herein. One embodiment of the present invention is operable in connection with Shockwave plug-in technology. Another embodiment of the present invention is operable in connection with Flash plug-in technology. Moreover, the present invention contemplates operation in connection with other plug-in technologies, now known or hereafter developed, that aspect not being a limitation of the present invention, but more a matter of design choice. By way of non-limiting example, hardware implementation could be employed, such as incorporation into a telephone receiver.

A musical composition created in accordance with the embodiments of the present invention may include one or more tracks (e.g., drum, bass, rhythm, and lead), each track being selectable by a user from a pre-recorded bank of audio samples. The bank of samples may reside locally on the user's computing device, or remotely, being accessible via a network in the latter case. Also, the samples may be loaded on the user's computing device unitarily, with the entire sample bank being loaded at once, or individually, as requested by the user. The samples may be compressed versions of waveform data, where each sample is played back by the computing device. Alternatively, the samples may be MIDI data samples, in which case the actual sound tones are generated by the computing device. The specific format and type of samples used in connection with the present invention not being critical, but rather a routine matter of design choice.

The applet also provides the user with control over any number of related audio play back parameters, such as stopping, playing, or pausing the current composition, or the attributes of each track, such as the selected sample sound, or volume, pan, and the ability to instantly mute and/or solo any one or more tracks. Effects, such as reverb, chorus, delay, and distortion, may also be used on individual tracks or the entire musical composition (also referred to as the mix) using appropriate software.

All interaction with the applet can be performed either on-screen using the computer device's cursor control device to click and drag and drop on elements of the visual interface, or via keyboard shortcuts (such as pressing the keys 1-4 to control muting status for tracks 1-4, respectively). As the present invention is applicable for virtually any computing device, including by way of illustration and not limitation, a cell phone, a microwave oven, server accessible via voice over the phone, or interactive television, the input methods may be numerous and varied (e.g., either via voice or some sort of tactile control).

The user of the applet can save, load, or transmit one or more musical compositions. Saving and loading can occur locally to the user's computing device, using local storage, or on a server, via a network. Transmission of the musical composition can occur via e-mail, or via any communication medium utilizing any computing device suitable for providing the functionality required by the present invention. For example, a user could create a musical composition on a cell phone (either as a local program or connecting to a server via wireless networking), interacting via voice or keypad, and transmit the composition as a voicemail, a regular phone call, or an e-mail.

The present invention is preferably server-based, and includes a client component and a server component. The server component preferably resides on a web server and comprises active server pages (.asp) software code to provide the various functionality of the present invention, as described in more detail herein. The client component is also referred to herein as the applet or plug-in (software code), and is described in further detail herein.

The client component provides an interface that enables a user to create, revise, save and transmit a musical composition. The interface provides certain functionality to the user including, by way of non-limiting example, the ability to play back a musical composition, to swap samples that comprise a musical composition, select a musical genre, save a musical composition, load a previously saved composition, and send, via e-mail, a musical composition. The interface can also provide a plurality of controls, preferably one for each track (each track corresponding to a selected sample) included in the musical composition. Each control can enable the user to separately turn each track on and off, and to adjust the volume for each track. Other functionality may also be provided by the interface, as a matter of design choice.

A user can advantageously receive the client component in one of two ways: by accessing a predetermined Internet site (e.g., the Internet address of the web server) whereby the client component is automatically transmitted to the user's computing device; or by receiving an e-mail with a tag to load the client component from the web server (the applet or plug-in of the present invention may thus be considered to be viral in that it is downloaded with each retransmission of a musical composition).

When a user receives the client component from a predetermined Internet site, the web server is located at a predetermined Internet address and interprets the user's navigation to that address as a request for the client component. Once the user's browser has been caused to navigate to the web server, the client component is automatically transmitted to the user's computing device for temporary storage on the user's hard drive and/or in the user's temporary memory (e.g., RAM, DRAM, SDRAM, etc.). The client component can also cause the interface to be displayed via the user's Internet browser (typically in a browser window). When the user receives the client component by navigating to the web server, a musical composition comprising a plurality of tracks, each track comprising a randomly selected or predetermined musical sample, is also communicated by the web server to the user's computing device. The user may then listen to and/or mix the tracks individually, change the volume of and swap the samples for each of the tracks, save a musical composition, e-mail a musical composition, and carry out various other options with regard to the creation, transmission/reception, and revise a musical composition in accordance with the present invention and as described in more detail herein. When a user desires to swap a sample, the samples could be swapped individually (download samples as they are requested by the client component), or, alternatively, all the samples could be transmitted by the web server to the user's computing device (download all samples as a “bank”, making each one instantly accessible). This difference can be achieved regardless of the manner in which the user receives the client component or applet.

If the user receives an e-mail with a tag to load the client component, the user will advantageously also receive a musical composition with the e-mail. The samples comprising the musical composition may have been selected by the sender of the e-mail. Advantageously, the samples that make up the tracks of the musical composition are not transmitted with the e-mail. Rather, a text string having an identifier indicating the network location of the samples is provided with the e-mail. The text string also serves to define certain characteristics of the musical composition including, by way of illustration and not limitation, identification of additional samples and their respective network locations, track volumes, mute settings and visual background settings, to name a few.

In a preferred embodiment of the invention, the identifier in the text string is a url and the network location is the web server, another server, or a plurality of servers. When a user receives the e-mail with a tag to load the client component, the client component may cause the recipient's computer to establish a connection to the Internet site identified by the identifiers in the text string, and may also cause that Internet site to automatically transmit one or more predetermined samples (as identified in the text string) to the recipient's computing device. No user action, such as hyperlinking or processing download instructions need be performed. With the samples and other information provided by the server or directed by the text string, the client component on the recipient's computing device can play back the musical composition sent with the e-mail. The recipient may revise that composition and save it as a new composition, revise it and transmit it back to the original sender and/or other recipient(s), send it un-revised to other recipient(s), or other options as described in more detail herein.

A musical composition may be created in a plurality of musical genres. While it is preferred that the samples of a particular musical composition all be selected from the same musical genre, it is also possible that a musical composition comprise a plurality of samples from different musical genres. A musical composition preferably comprises a plurality of separate and distinct musical tracks, with each sample comprising a separate track. Alternatively, a single-track composition is also contemplated by and within the scope and spirit of the present invention.

When a user selects a sample, a request is transmitted by the client component to a server identified by the identifier in the text string to transmit the selected sample to the client component. In addition to selecting the samples for inclusion in an e-mail, the user may mix the volume levels, and possibly other attributes of selected samples to create a musical composition and may save the musical composition. However, the musical composition need not be saved locally on the user's computing device. Rather, a text string that is a representation of the musical composition is created by the client component, and only the text string may be saved locally on the user's computing device, and/or in a manner accessible via the web server. The text string includes certain information for the musical composition such as, for example, an identifier (e.g., url) for each musical sample in the musical composition. The text string may also include information for each sample such as, for example, volume, or other useful information, as a routine matter of design choice. That text string is sent along with an e-mail-transmitted in accordance with embodiments of the present invention and provides information that enables a recipient to receive and play back the musical composition created and transmitted by the sender. Thus, only a tag to load the applet and a text string are sent with the e-mail. If a user had previously cached the client component, it will not be retransmitted by the web server. Note that if the strings are stored on the server-side, they could be kept in a database, either on the webserver or on a separate server. Then, they would be accessed via the webserver.

When a user sends a musical composition via e-mail in accordance with preferred embodiments of the present invention, the client component communicates with the web server. The web server accommodates a log of such communication, say, using a database, including the sender and recipient(s) e-mail address, text string for each e-mail and for each musical composition, and other information related to each e-mail (the webserver remains responsible for accessing and storing this data on the database/database server). The web server also preferably communicates each e-mail message from a sender to an e-mail server, which carries out the e-mail transmission to the recipient(s). It will be apparent to persons skilled in the art and from the disclosure provided herein that the web server and e-mail server described herein may comprise a single computer having software installed thereon to provide the desired different functionalities of the web server and e-mail server. Alternatively, separate computers may be provided.

Pre-recorded samples stored on the web server or on another server may be in compressed, Shockwave audio (SWA) format, Flash format, or other suitable format, as a matter of design choice. For the Shockwave embodiment, a sample or a plurality of samples may be bundled into a single file for communication by the server to the user's computing device to ensure synchronization between and among the samples in case of network latency or other network-introduced errors. For the Flash embodiment, the samples may be communicated as a library file. In either case, samples also may be communicated individually as requested by the client component.

The client component is operable in connection with a client-based e-mail application such as, for example, the e-mail application available from Microsoft Corporation under the tradename “Microsoft Outlook.” The client component is also operable in connection with a web-based e-mail application such as, for example, the e-mail applications available from Yahoo!, Inc., Hotmail, and AOL, to name a few. The client component consumes little user memory, and each pre-recorded sample is less than approximately 11.5K in size (based on a predetermined sample size (e.g., 8 seconds) and desired encoding quality (e.g., 16 kbps) and other attributes, such as mono vs. stereo and audio bitrate (such as 22.05 Khz vs. 44.1 Khz). It will be obvious to persons skilled in the art from the disclosure provided herein that file size may vary. The present invention's utilization of a compressed file format permits the client component to automatically download and begin playing a user's musical composition extremely quickly after the recipient has opened the e-mail. In addition, a user can cause the client component to be downloaded to another user by simply sending or re-sending an e-mail containing a tag to download the client component from the server.

In another embodiment of the present invention, a client component is provided that enables a user to add audio content to an e-mail (or even other types of content, such as image content, the term audio content, for simplicity, being understand to encompass such other content). The added audio content may be a predetermined sound or musical clip selected from a library file, or it can be a user-created musical composition. The client component inserts a tag (e.g., a HTML tag) in an e-mail message. The tag will direct the recipient's computing device to attempt to load and playback a Flash movie in the recipient's e-mail window. The Flash movie will be the musical composition and will playback without user intervention, preferably in a loop a predetermined number of times. The Flash movie may appear to the recipient like an Internet browser interface toolbar, and may contain certain buttons for user-control of the audio content. When the recipient opens the e-mail message containing the added audio content, the audio automatically begins to play back. Since Flash content is cached, the client component need not download the specific sound file for every message that references that file. Thus, subsequent playback of the same audio content does not require that the audio content be communicated by the server because it is cached on the client's computing device.

The client component also determines if a new or revised client component is available for download from the server. By checking for new versions of itself based on a server record of the recipient e-mail addresses, the client component can automatically prompt the user to enable the client to update itself.

Another aspect of the present invention provides for the addition of music capabilities to any interactive tool.

In addition, a user can be provided with access to pre-recorded samples of well-known artists for a plurality of genres. Thus, a user may create a musical composition for their favorite artist (music artist or otherwise).

Various other embodiments of the present invention are also contemplated. For example, an on-line (Internet-based) musical lottery, on-line karaoke, an on-line musical studio, to name a few. The above-described embodiments of the present invention may be provided individually, or in any combination, as a matter of design choice. In addition, non-musical content such as, for example, video, still picture, and others now known or hereafter developed content may also be utilized in accordance with the embodiments of the present invention.

The present invention accordingly comprises the features of construction, combination of elements, arrangement of parts, which will be exemplified in the disclosure herein, and the scope of the present invention will be indicated in the claims.

### BRIEF DESCRIPTION OF THE DRAWINGS

In the drawing figures, which are merely illustrative, and wherein like reference characters denote similar elements throughout the several views:

FIG. 1 is a schematic diagram of a network in connection with which the present invention may be used;

FIGS. 2A-2B are flow diagrams of an exemplary method of communicating content between and among computing devices in accordance with the present invention;

FIGS. 3A-3D are exemplary depictions of embodiments of an interface provided by the client component when used in connection with a Shockwave plug-in in accordance with an embodiment of the present invention;

FIG. 4 is an exemplary depiction of an e-mail interface provided by the client component when used in connection with a Shockwave plug-in in accordance with an embodiment of the present invention;

FIG. 5 is an exemplary depiction of an interface provided by commercially available e-mail software, within which is depicted an interface provided by the client component when used in connection with a Shockwave plug-in in accordance with an embodiment of the present invention;

FIGS. 6A-6D are exemplary depictions of embodiments of an interface provided by the client component when used in connection with a Flash plug-in in accordance with an embodiment of the present invention;

FIG. 7 is an exemplary depiction of an e-mail interface provided by the client component when used in connection with a Flash plug-in in accordance with an embodiment of the present invention;

FIGS. 8A-8C are an exemplary depiction of an e-mail interface via which a user may add sounds to an e-mail message in accordance with an embodiment of the present invention; and

### DETAILED DESCRIPTION OF THE PREFERRED EMBODIMENTS

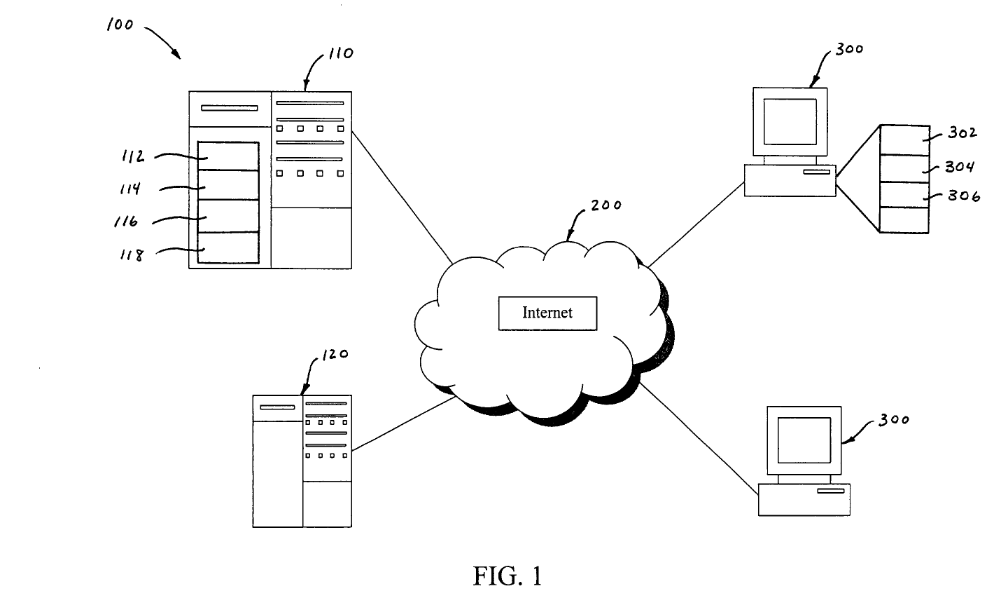

Referring now to the drawings, the various embodiments of the present invention will now be discussed in detail. With reference first to FIG. 1, a system 100 is depicted for communicating, creating and interacting with content between and among a plurality of computing devices. In FIG. 1, the computing devices are connected or connectable to a communications network 200 such as, for example, the Internet. The depiction of a network 200 such as the Internet in FIG. 1 is provided as an illustrative, non-limiting example of an embodiment of the present invention, and is not intended to limit or otherwise define the scope or spirit of the present invention. The present invention is operable in connection with any type of computing device and over any type of communications network, including, but not limited to, a LAN, WAN, intranet, extranets, wireless networks, and any other now known or hereafter developed medium over which electronic, digital, and/or analog data may be communicated. Similarly, the computing device depicted in FIG. 1 and identified by reference character 300 is shown as a personal computer. However, the present invention need not be limited to any type of computing device, and may be used in connection with any computing device capable of communicating with another computing device and providing other functionality, as described in detail herein. Such other computing devices include, but are not limited to, personal digital assistants, cellular phones, web-enabled cellular telephones, hard-wired telephones, mobile computers, personal computers, Internet appliances and the like. Furthermore, the servers described herein may be of any compatible type, running any software, and the software modules, objects and plug-ins described herein may be written in any programming language. Lastly, the database and storage devices described herein may utilize any storage technology, including, for example, local computer memory, network attached storage, and any known storage medium, such as magnetic or optical.

With continued reference to FIG. 1, a system 100 for communicating, creating and interacting with content between and among computing devices in accordance with the present invention preferably comprises a web server 110 having general purpose software 112 stored on a data storage device (e.g., hard drive) and operable in connection with a processor thereof. The general purpose software may include, by way of non-limiting example, operating system software, database software, communication software, security software, and other types and categories of software that may be necessary or useful to enable a server to connect to the Internet and provide the functionality as described herein. The general purpose software just described is illustrative and non-limiting. It would be apparent to persons skilled in the art that other software may be provided on the server, as a routine matter of design choice. In addition, the web server 110 has special purpose software 114 stored on a data storage device and operable in connection with a processor thereof, as described in more detail below. The web server 110 may communicate with an e-mail server 120 which is also configured with general purpose software 112. The web server 110 and e-mail server 120 are each “located” at a predetermined Internet address, identifiable by an url (e.g., the webserver.com and the e-mailserver.com). The interconnection between and among the servers 110, 120, network 200, and user computing devices 300 may be achieved using any now known or hereafter developed interconnection and data communication devices (including both computer hardware and software), transmission medium, and methods; that aspect not comprising a limitation or inventive feature of the present invention. Thus, a detailed description of the interconnection between and among the various computers depicted in FIG. 1 need not be provided herein.

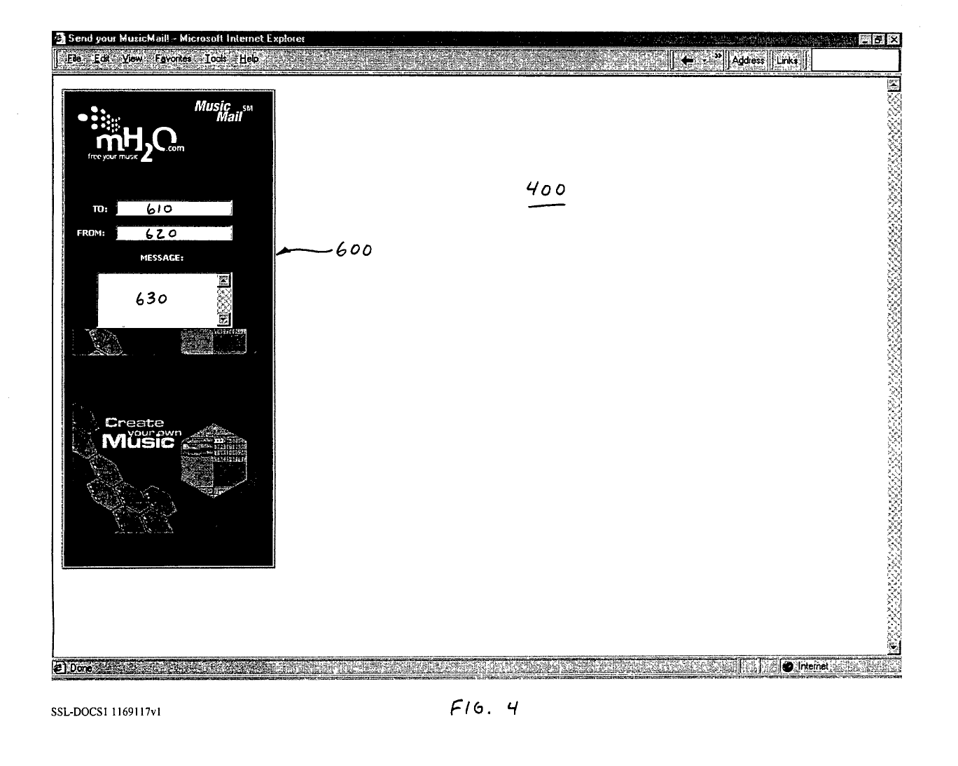

The special purpose software 114 on the web server 110 may be active server pages (.asp) and preferably controls the transmission of the client component to a user's computing device 300, and controls transmission of a musical composition via e-mail from the user to one or more recipients via the e-mail server 120. The special purpose software 114 on the web server 110 also facilitates the transmission of an e-mail message together with the client component and musical composition from a user to one or more recipients. When a user selects an e-mail (or send) option via the interface 500 or 800 provided by the client component 304, the client component 304 causes an e-mail interface 600 (see, e.g., FIG. 4) to be displayed within a browser window 400 on the user's computing device 300. The e-mail interface 600 provides a plurality of fields within which a user may enter certain information. For example, the e-mail interface 600 preferably includes a “To” field 610 within which a user may enter one or more recipient e-mail addresses, a “From” field 620 within which the user may enter his/her e-mail address, and a “Message” field 630 within which the user may enter a text message to accompany the musical composition.

When a user transmits a musical composition in accordance with the present invention, the text string 306 (see, e.g., FIG. 1) created by the client component 304, the recipient address(es), the sender (user) address, and the text message (if any) are received by the special purpose software 114 on the web server 110 and saved in an e-mail database 118 maintained thereon. In that manner, the web server 110 manages and maintains a record of all e-mail transactions carried out in accordance with the various embodiments of the present invention.

Upon receipt of an e-mail request and the corresponding e-mail message, which may include the client component 304, a text string defining certain characteristics of the musical composition 306, musical composition, sender/recipient(s) e-mail addresses, and a text message, the special purpose software 114 on the web server 110 creates a new record in the e-mail database 118, and forwards the e-mail message to an e-mail server 120. The web server 110 and e-mail server 120 may comprise a single computer or, alternatively, they may comprise separate computers, as a routine matter of design choice. The e-mail server 120 facilitates transmission of the e-mail message to the identified recipient(s). The specifics of e-mail transmission are well known to persons skilled in the art and thus need not be described in detail herein.

When a user causes his/her Internet browser to navigate to the Internet address of the web server 110, the web server 110 automatically transmits the client component 304 (i.e., software code) to the user's computing device 300. The client component 304 is downloaded or cached on the user's computing device 300. The operation of the client component 304 in connection with the user's computing device 300 is slightly different for a Shockwave plug-in and a Flash plug-in. Thus, each will be discussed separately and in detail below.

While the functionality of the client component 304 is essentially the same for the Shockwave and Flash embodiments, there are some differences between the two embodiments. For example, in the Shockwave embodiment, only the samples comprising the musical composition are initially transmitted to the user. In addition, a user may swap samples mid-play back with the Shockwave embodiment without having the musical composition restart for every sample change (although the musical composition may restart, as a matter of design choice). Also, the Shockwave embodiment only loads sample(s) as they are requested (either by the client component 304 when the musical composition is first transmitted to the user's computing device 300 or when requested by the user).

In contrast, the Flash embodiment transmits all of the samples associated with a musical composition at the time the musical composition is transmitted to the user. Thus, if a user elects to playback the composition, the samples are already cached on the user's computing device. If a user elects to mix the musical composition, the client component 304 requests all samples corresponding to the musical composition to be downloaded. As used herein, the terms sample and samples may refer to an individual sample, a plurality of sample, or a sample bank, which may comprise a plurality of sample from a particular genre, organized by a particular musical instrument (e.g., guitar, drums, bass, etc.), or categorized in some other manner, as a routine matter of design choice. Unless used otherwise, the terms sample, samples and sample bank are used interchangeably herein. Both the Shockwave and Flash embodiments can save musical compositions to the user's Internet browser cache, allowing for multiple saved versions.

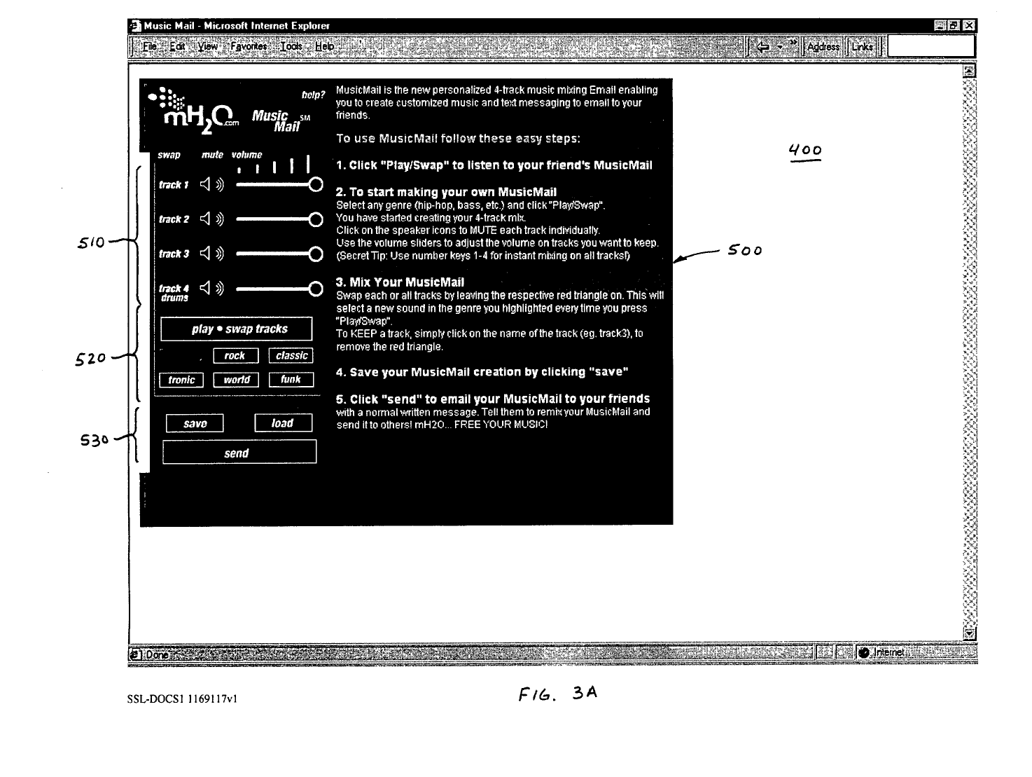

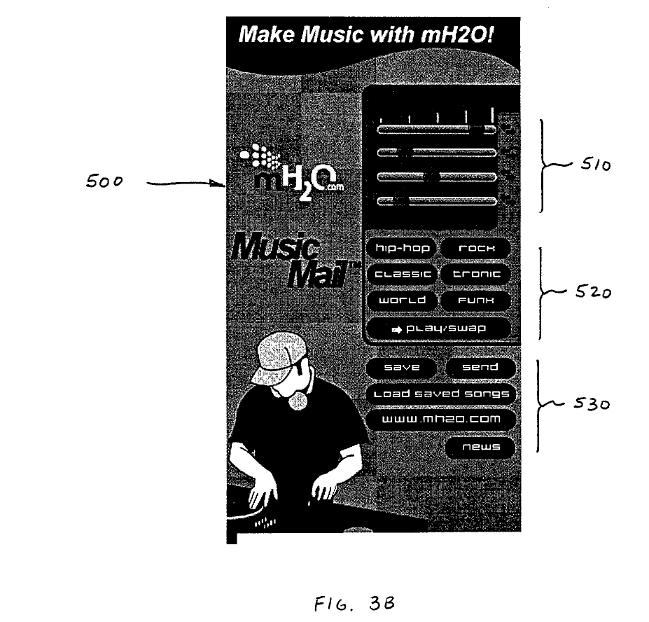

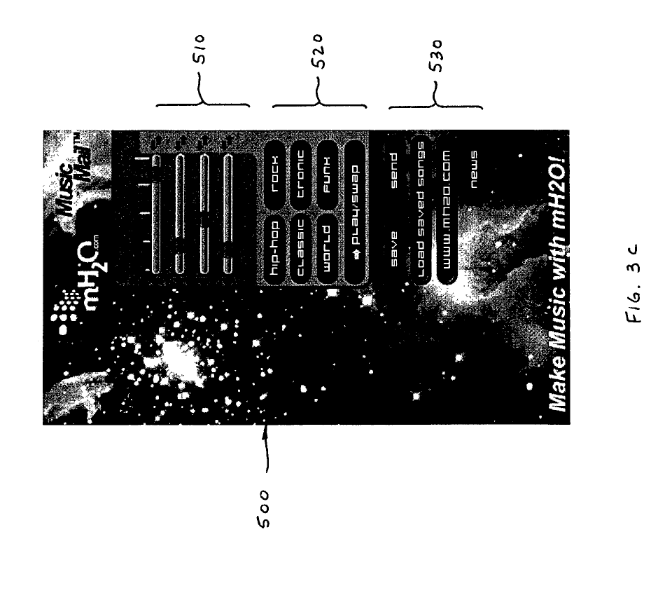

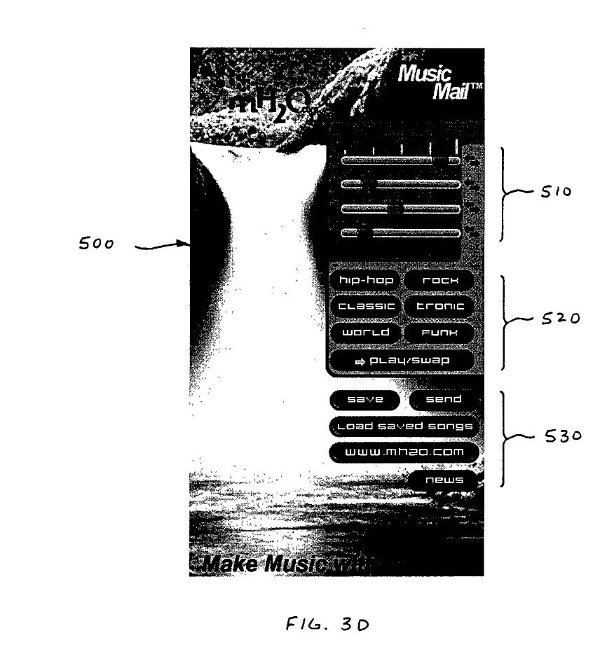

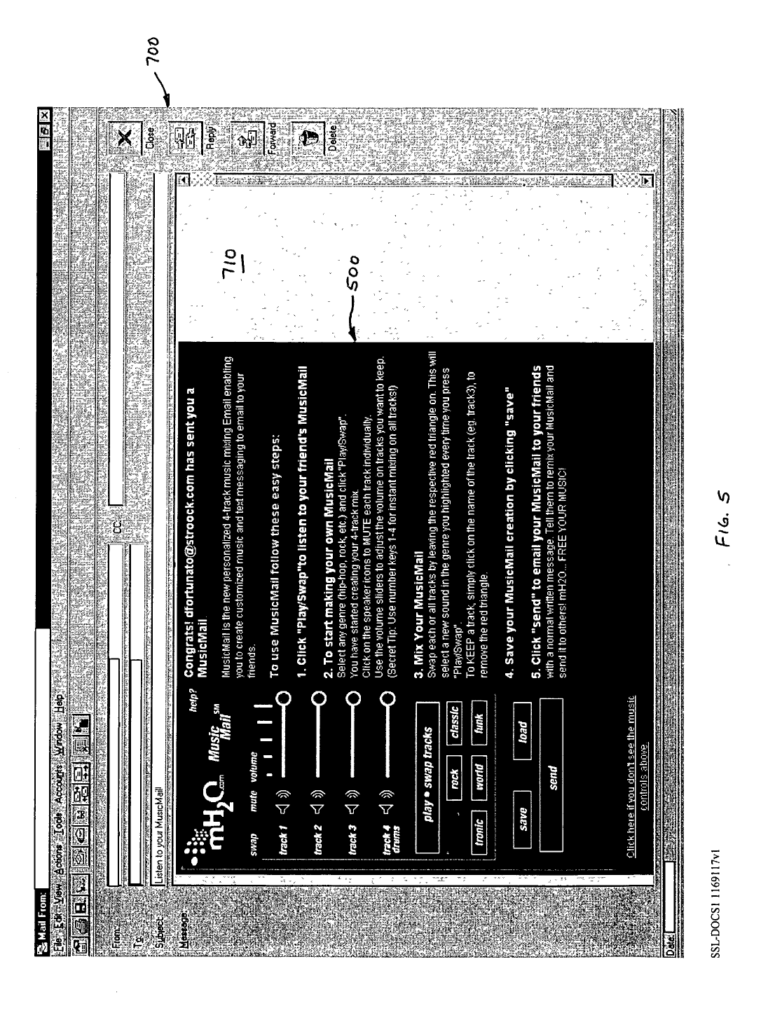

With reference to FIGS. 3A-3D, operation of the client component 304 in connection with a Shockwave plug-in will now be described. Upon receipt of the client component 304 from the web server 110, or upon receipt of the client component 304 via a tag in an e-mail from another user, the client component 304 will cause an interface 500 to be displayed within a browser window 400 on the user's computing device 300, as depicted in FIG. 3A, or within a window 710 of an e-mail interface 700, as depicted in FIG. 5. The web server 110 also transmits a musical composition to the user's computing device 300. In a preferred embodiment, the musical composition comprises four tracks, with a sample corresponding to each track. Those samples 116 may be randomly selected by the client component 304, or they may be selected when a user creates a musical composition (such as when a user receives the client component along with an e-mail message). In either case, the samples are not transmitted along with the e-mail or client component 304. Rather, each sample is identified by one or more identifiers contained in a text string that is transmitted with the e-mail or client component 304.

FIGS. 3A-3D are exemplary representations of an interface 500 provided by the client component 304 in accordance with the Shockwave embodiment of the present invention. In each instance, the client component 304 was transmitted directly by the web server 110 to the user's computing device 300. The interface 500 includes four track controls 510, one for each musical sample in the musical composition. Each track control 510 enables a user to separately control various aspects of each sample. For example, each track control 510 includes a volume slider. A user may also toggle individual tracks on and off for swapping (only tracks that are toggled on are swapped), mute individual tracks, and collectively or individually replace the musical samples. Using the track controls 510, a user may mix the musical composition, incorporating desired samples, adjusting their respective volume, etc.

The interface 500 may also include a plurality of sample controls 520 that may identify different musical genres (e.g., hip-hop, rock, classic, tronic, world, funk, etc.). For each identified musical genre, one or more musical samples 116 are available from the web server 110 for incorporation in a musical composition. The sample controls 520 may also include a “play/swap” feature that enables a user to collectively or individually replace or swap musical samples, and to play back a musical composition. When a user selects a musical genre, and then selects “play/swap”, the client component 304 transmits a request to the web server 110 to transmit randomly selected musical samples 116 in the selected genre. The number of samples sent by the web server 110 depends on the track control 510 settings. More specifically, if a user toggles a track on, and the selects the “play/swap” sample control 520, only the tracks that are toggled on will be swapped.

The interface 500 also includes transmission controls 530 that enable the user save a musical composition, send a composition by e-mail, load previously saved composition(s) (songs), connect to one or more predetermined Internet sites, and other functionality, as a matter of design choice. When a user selects the “save” option, the client component creates a text string 306 in local browser cache that includes an identifier for each sample included in the musical composition. That identifier preferably comprises the address (url) in the network 200 at which the sample is located and from which the sample may be communicated to the user's computing device 300. The text string 306 also includes information about the url address, mute status, volume and other play back characteristics for each track. The text string 306 may be saved locally, on the user's hard drive, and/or it may be saved on the web server 110 or at some other location in the network 200.

When a user selects the “load” option, the client component 304 causes a new screen to be displayed, within which may be displayed musical compositions previously saved by the user. If a previously saved composition is loaded, the client component 304 interprets the identifiers in the text string 306 corresponding to the loaded musical composition and communicates a request to the network location of each sample in the musical composition so that the sample may be caused to be transmitted to the user's computing device 300.

When a user selects the “send” option, the client component 304 causes an e-mail interface 600 (see, e.g., FIG. 4) to be displayed in a window 400 of the browser. In a preferred embodiment, the e-mail interface 600 includes a “To” field 610 within which a user may enter one or more recipient e-mail addresses, a “From” field 620 within which the user may enter his/her e-mail address, name, or other personal identifier, and a “Message” field 630 within which the user may enter a text message to accompany the musical composition.

As mentioned above, the user may also receive the client component 304 via a tag included in an e-mail. As depicted in FIG. 5, the interface 500 is displayed within a window 710 of an e-mail interface, generally designated as 700. In addition to the tag for the client component 304, the user (recipient) receives a text string representation of the musical composition. By selecting the “play/swap” sample control 520, the user (recipient) may cause the musical composition to play back. The user may also revise the musical composition using the track controls 510 and sample controls 520. If the user has revised the received musical composition, the user may save it, and/or send it to the original sender and/or other recipients, as a matter of design choice. All the functionality available to a user who received the client component 304 directly from the web server 110 is also available to a user who receives the client component 304 with an e-mail.

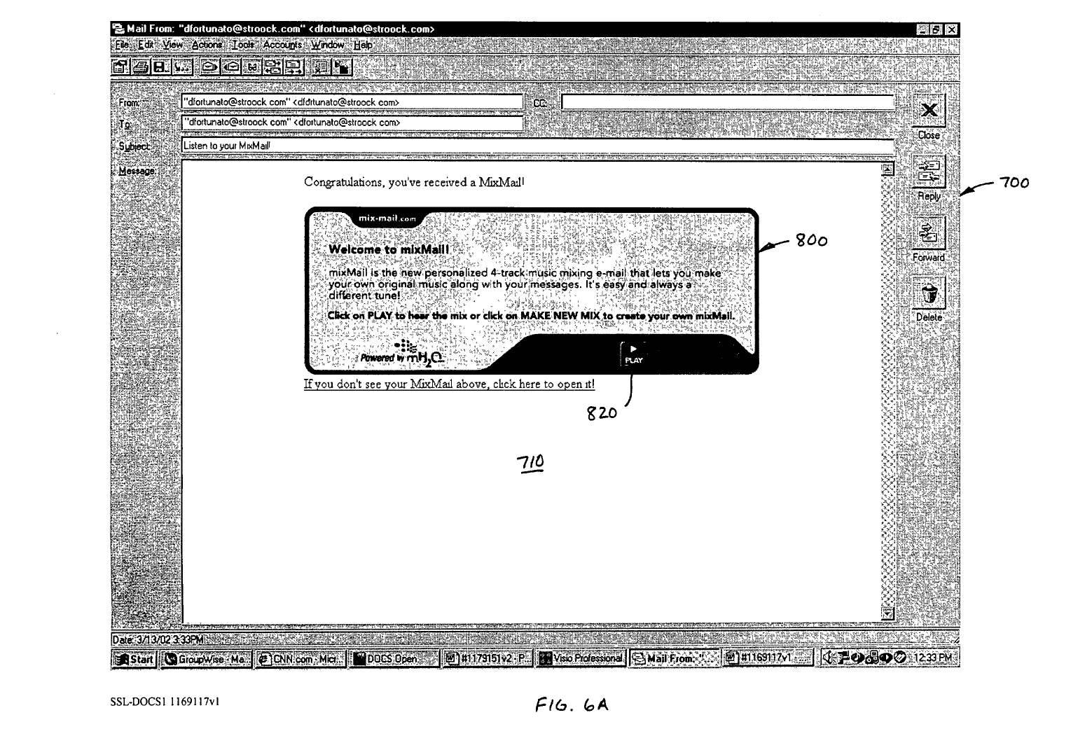

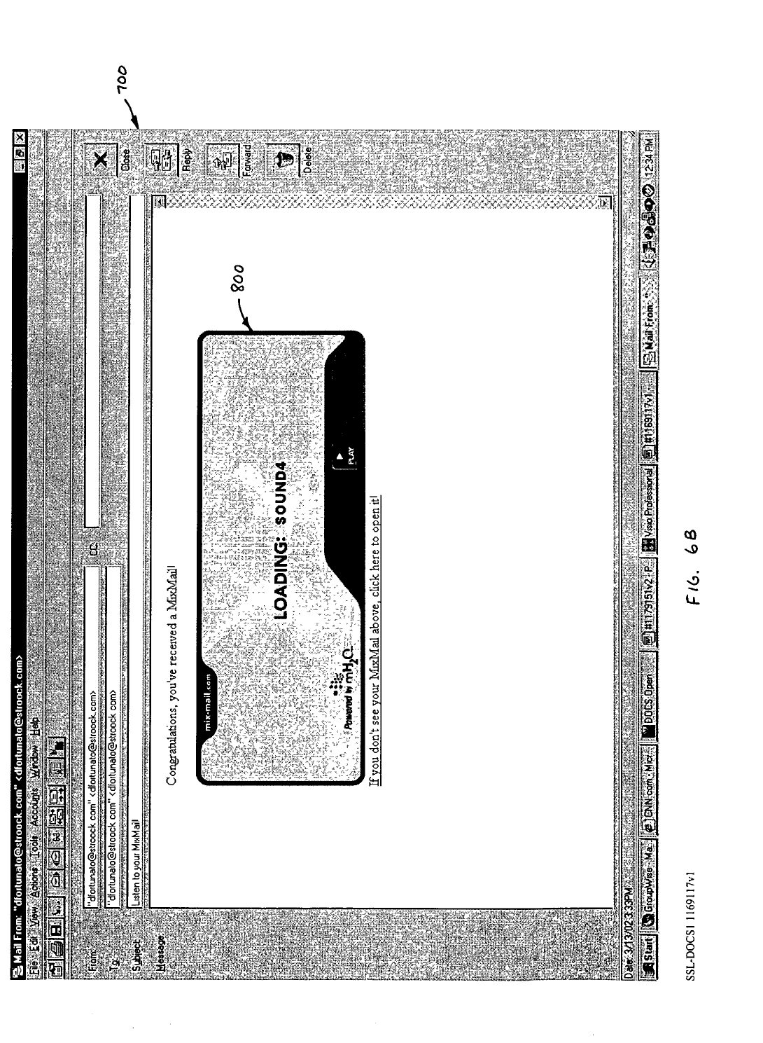

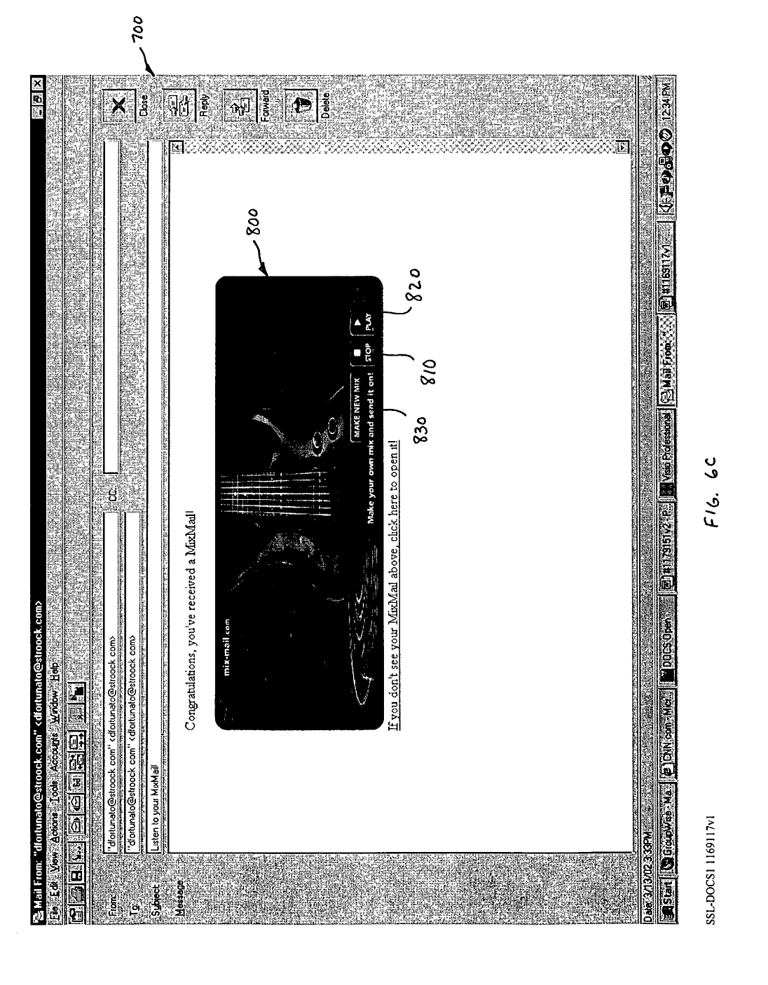

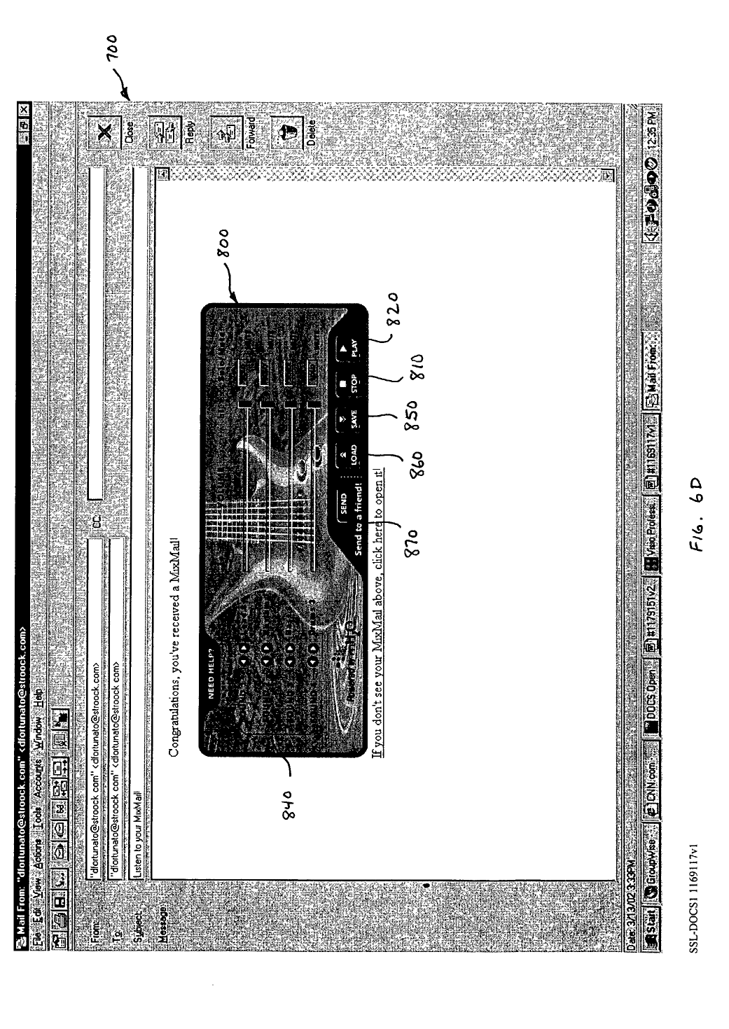

Referring next to FIGS. 6A-6D, the operation of the client component 304 in connection with a Flash plug-in will now be described in detail. An exemplary interface 800 provided by the client component 304 when used in connection with a Flash plug-in is depicted in those figures. It should be noted that the interface 800 differs depending upon the functionality being provided by the client component 304, as described in more detail below. It should also be noted that FIGS. 6A-6D depict the interface 800 displayed within an e-mail interface 700. As noted previously, that is one way in which the present invention may be utilized, the other being via direct communication between the user's computing device 300 via a web browser and the web server 110.

When a user receives an e-mail with a musical composition and a tag for the client component 304, the interface 800 depicted in FIG. 6A is displayed. When a user selects the “Play” button 820, the four samples that comprise the musical composition are loaded from the web server 110 to cache memory on the user's computing device 300, as depicted in FIG. 6B. Once the four samples are loaded into memory of the user's computing device 300, the interface 800 depicted in FIG. 6C is displayed. The user may then select the “Play” button 820 to cause the musical composition to play back, and the “Stop” button 810 to stop play back. It the user desires to create a new musical composition, the “Make New Mix” button 830 may be selected. When that occurs, all samples available for a particular musical genre or corresponding to a sample bank are loaded from the web server 110 to cache memory on the user's computing device 300. The interface 800 depicted in FIG. 6D is then displayed. The user may then create a musical composition using the controls provided via the interface 800, in much the same manner as described above with regard to FIGS. 3A-3D. At this point, the functionality of the Shockwave and Flash embodiments of the present invention function essentially the same, save for differences in their respective interfaces. It will be obvious to a person skilled in the art and from the disclosure provided herein that the number of samples described in the preceding exemplary embodiment are by way of illustration, and not limitation, and that any number of samples may be provided, as a routine matter of design choice.

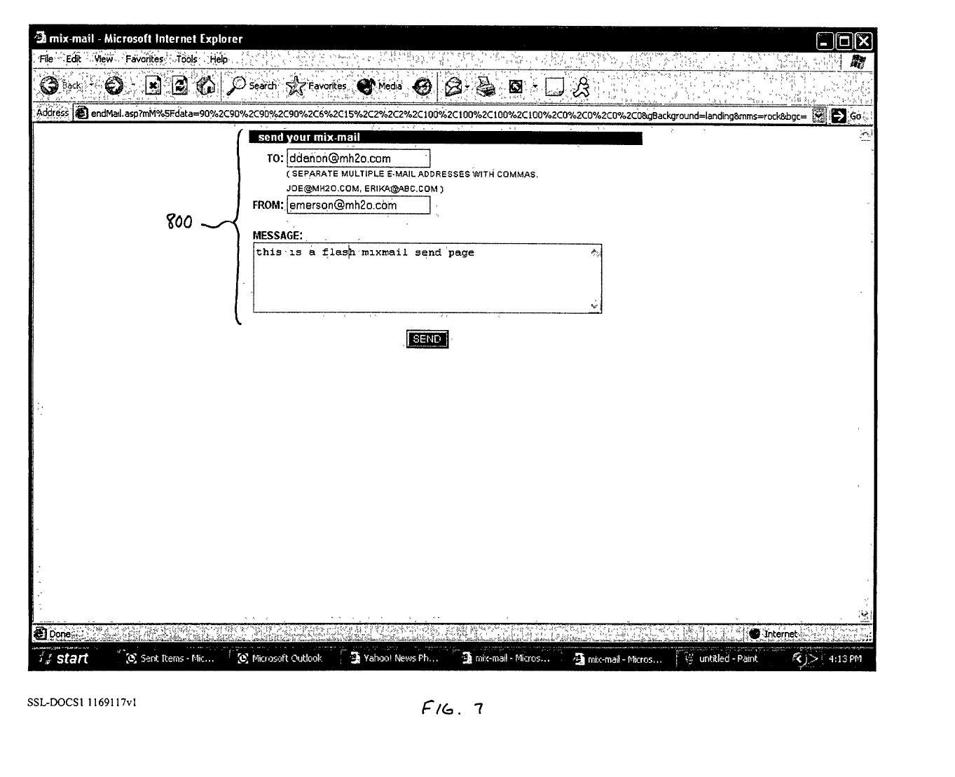

A musical composition may be sent via e-mail to one or more recipients using an e-mail interface 800, such as is depicted in FIG. 7.

The web server 110 generally serves and manages a web page or a plurality of web pages at a predetermined Internet site, provides for transmittal of web pages (e.g., HTML, DHTML), and provides for communication of the client component to a recipient. The web server software may also provide for the storage, retrieval, and transmission of one or more musical samples 116. The special purpose software 114 of the web server 110 also provides functionality to transmit a sample or a plurality of samples to a user via the network 200. Alternatively, the musical samples may be stored on another server, as a matter of design choice, and transmission of a sample may be facilitated by that server or by the web server 110.

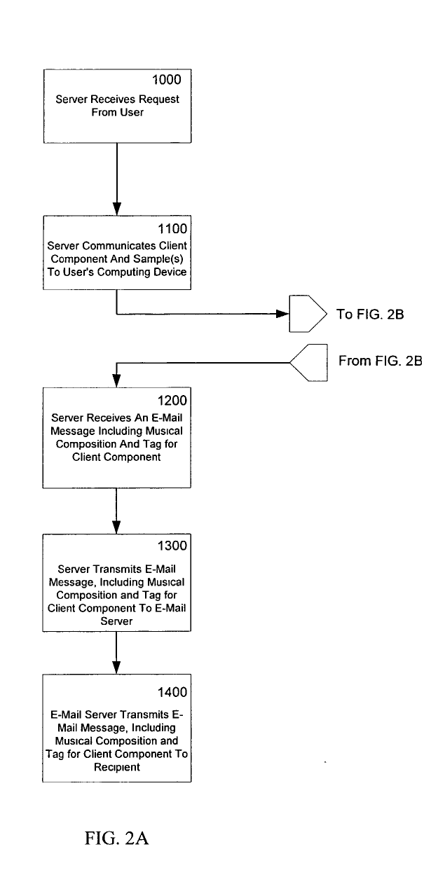

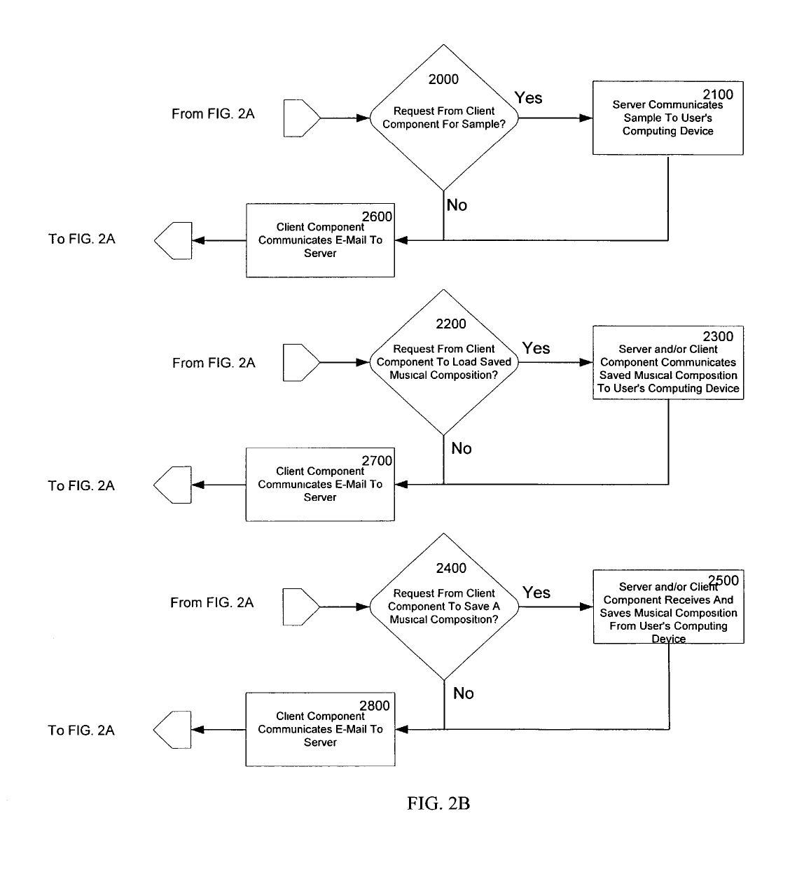

Referring next to FIGS. 2A and 2B, a method for communicating content between and among computing devices in accordance with embodiments of the present invention will now be discussed. The flow diagrams depicted in FIGS. 2A-2B are directed to the embodiment in which a user receives the client component 304 by causing a computing device 300 to connect to the web server 110.

At step 1000, the web server receives a request from the user's computing device 300 to transmit the client component 304. That step occurs automatically when the user causes his/her computing device to navigate to the web server's Internet address via a web browser. In response, at step 1100, the web server transmits to the user the client component 304 (applet or plug-in) and a musical composition comprising a plurality of tracks, each track comprising one of a plurality of samples. As noted above, the samples are not transmitted initially with the client component 304, rather a text string including identifiers for the location(s) of the samples is transmitted.

Once the user has received the client component 304 and musical composition, various functionality provided by the client component 304 is available to the user with regard to the musical composition. For example, and with reference to FIG. 2B, at step 2000, the client component 304 may request a sample from the server 110 (if the user selected to swap one or more samples of the composition). In response, the web server 110 communicates a sample to the user's computing device 300, at step 2100. Alternatively, the client component 304 may request that the web server 110 transmit a previously saved musical composition, at step 2200, or the client component 304 may retrieve a previously saved composition stored locally on the use's computing device 300.

The web server 110 or user's computing device 300 attempts to locate the requested musical composition, and communicates it to the user's computing device 300, at step 2300. Yet another alternative is that the client component 304 request that the web server 110 or user computing device 300 save a musical representation, at step 2400. In that case, the client component 304 communicates a representation of the musical composition to the web server 110 or user's computing device 300 for storage thereon.

In yet another alternative, the user may elect to send a musical composition to one or more recipients. At step 1200 of FIG. 2A, the client component 304 (in response to a request by the user to send the musical composition via “Send” button) communicates a text message and a representation of the musical composition to the web server 110. At step 1300, the web server 120 creates and transmits the e-mail message to an e-mail server 120 which, at step 1400, transmits the e-mail, including a tag for the client component 304 and the musical composition, to the recipients.

In yet another embodiment of the present invention, an audio component such as a music or sound sample (collectively referred to herein as “sounds”) may be added to an e-mail, instant message (e.g., SMA, MMS, text message, etc.), chat session, etc. Although applicable to all of the foregoing, and other now known and hereafter developed equivalents, this embodiment will be described in terms of an e-mail message; it being obvious to a person skilled in the art and from the disclosure provided herein that such description includes all such variations of this embodiment of the present invention. The added sound sets a “mood” for the e-mail (e.g., happy, sad, cool, mad, celebrate, etc.) In accordance with this embodiment, when composing a text message, a user may select one of a plurality of preprogrammed sounds that will automatically playback when the recipient of the text message receives and opens the message. Client software such as, for example, a plug-in, is installed on a user's computing device in any now known or hereafter developed manner including, by way of example and not limitation, download from a predetermined Internet site, CD-ROM, and pre-installation by a computing device manufacturer, to name a few. The client software includes a core set of sounds that may be added to an e-mail message, as described below.

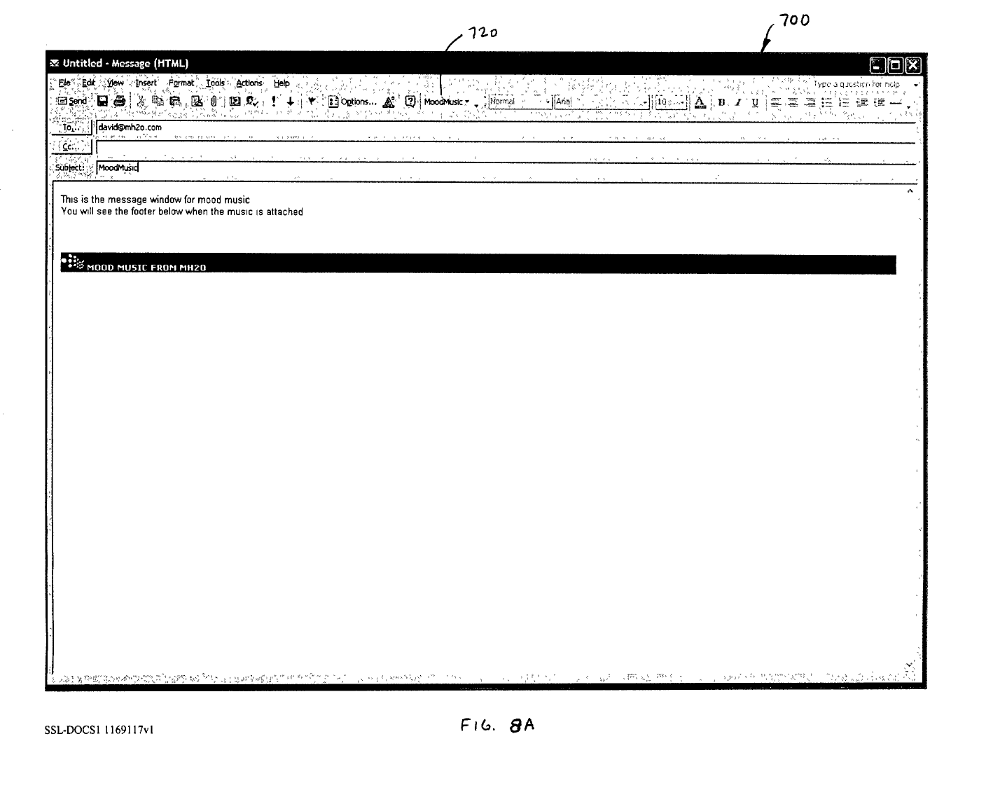

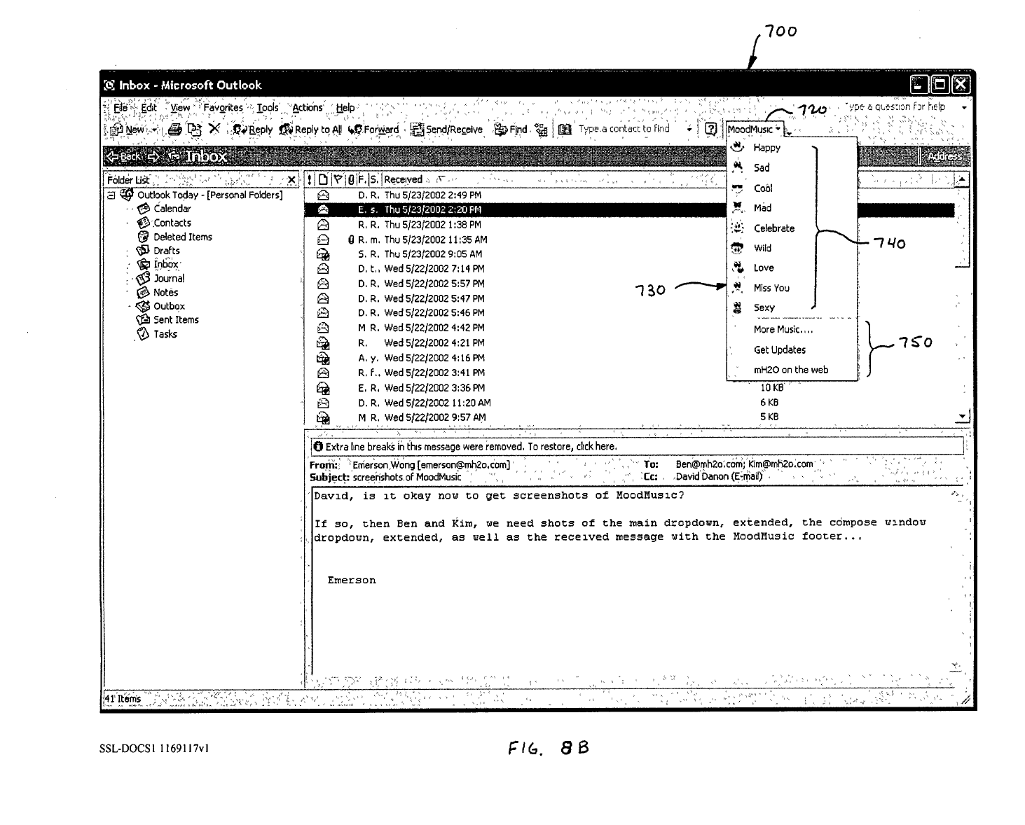

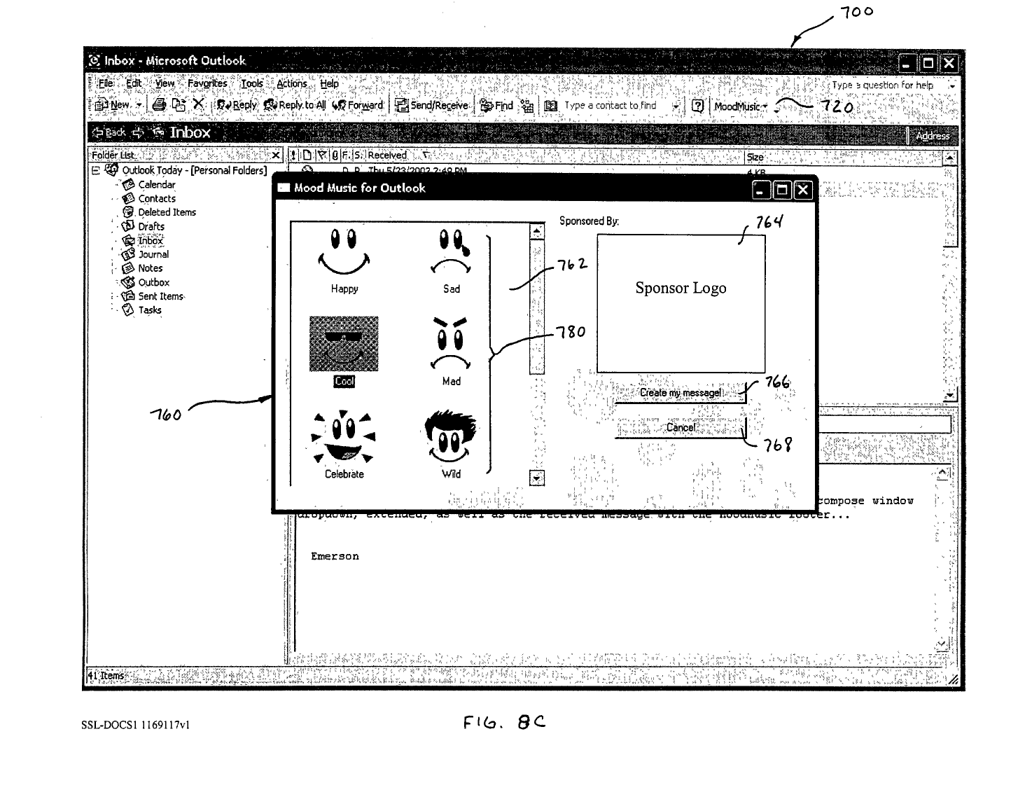

With reference next to FIGS. 8A-8C, the above-described embodiment of the present invention will now be discussed in detail. The client software may add functionality to the e-mail interface 700, including a button 720 that provides a user with access to a pulldown menu 730 which displays representations of a plurality of sounds 740 available to the user for addition to the e-mail message. Alternatively, the user may select a sound by browsing the Internet for available sounds, or the user may compose an audio composition via an interface (see, e.g., FIGS. 3A-3D) that permits the user to select and mix a plurality of sounds; with the sounds being stored locally (on the user's computing device or a data storage device connectable to the user's computing device), remotely (on a server or servers connectable to the user's computing device via a network), or available to the user in real-time, as a matter of design choice. The pulldown menu 730 also displays other options 750 available to the user for adding sound to the e-mail message or for updating the plurality of sounds 740.

Moreover, it will be appreciated that forms of data other than sound content, for example, images, also could be associated with the e-mail message. Further, the message to which the other data is associated need not be limited to text; this invention also could be employed with voice messages, say, by playing an audio cue along with a live telephone call or pre-recorded telephone message.

Prior to selecting a sound, a user may sample the sounds via a sample interface 760, as depicted in FIG. 8C. The sample interface 760 provides a sample window 762 within which are depicted graphical representations 780 of each of the plurality of available sounds 740. When a user selects one of the graphical representations 780, the sound associated therewith is played back to the user. In one embodiment, a sponsor may be associated with a particular sound. When the user selects the graphical representation 780 for that sound, a sponsor logo 764 is displayed in the sample interface 760. Thus, a plurality of sponsors may elect to have an association established between their respective brand and a sound. Also provided in the sample interface 760 are user-selectable buttons for creating an e-mail message 766 and closing the sample interface 760, depicted as a “Cancel” button 768 in FIG. 8C.

In use, a user creates a text e-mail message using the e-mail software. When the text message is complete, or at any time during creation of the message, the user may select one of the plurality of sounds 740 via the pulldown menu 730 to add to the e-mail message. When a user has selected a sound (or composed a mix of sounds) for inclusion with the e-mail message, the client software inserts HTML tags in the e-mail message at the time the message is sent. The inserted HTML tags instruct the recipient's e-mail software to attempt to load a Flash movie (from a server) within the e-mail message. The Flash movie may be displayed anywhere within the e-mail message, and may be depicted graphically, as part of the e-mail interface, or it may be hidden (with the sound still being audible to the recipient), as a matter of design choice. The selected sound is contained within the Flash movie, so as the HTML e-mail loads the Flash movie, the sound is part of that transfer, since it is embedded within. The Flash movie can have the look and feel of a Windows toolbar, and may thus appear to be a part of the e-mail interface 700. The Flash movie may include a plurality of controls for the sound such as, for example, volume, a link to listen to the sound (in case the Flash movie doe not function as intended by the present invention), and a link to download the client software (i.e., the plug-in). The Flash movie will also load the selected sound from a server for playback simultaneous with the recipient's reading of the e-mail message.

For users having the client software already installed on their respective computing devices, receipt of e-mail with a HTML tag for a sound in accordance with this embodiment of the present invention will cause the sound added to the e-mail to be replicated on the user's computing device, thereby making it unnecessary to download sound(s) each time a user desires to attached a sound to an e-mail message. The client software resident on the user's computing device will store and maintain the sound(s) on the user's computing device. On the other hand, when a recipient receives an e-mail message with a HTML tag for a sound, the Flash movie will always be downloaded when the recipient opens the e-mail message, unless the Flash movie for a particular sound was previously cached and remains cached when the recipient opens the e-mail message.

It should be noted that the various embodiments of the present invention have been described herein in terms of operation in connection with a personal computer connected or connectable to the Internet. Such description is provided by way of illustration, and not limitation. The present invention need not be limited, and is not intended to be limited to any type of computing device. Moreover, the type of network in connection with which the present invention is utilized also need not be limited in any manner to the networks described herein.

As used herein, the terms “computer” and “computing device” are intended to be construed broadly, and in a non-limiting manner, and to include, without limitation and by way of illustration only, any electronic device capable of receiving input, processing and storing data, and providing output (both input and output typically being digital data), and that is connectable in any manner and by any means to a network such as, for example, the Internet. A computer may be a computer of any style, size, and configuration including, without limitation, a server, workstation, desktop, laptop, Internet appliance, notebook, personal digital assistant (PDA), cellular phone (Internet enabled or otherwise), or other now known or hereafter developed device. A computer typically includes the following components: a central processing unit (CPU or processor) operable in connection with software (e.g., operating system, application programs, etc.), a hard drive unit (HDU), permanent memory (e.g., ROM), temporary memory (e.g., RAM, DRAM, SRAM, etc.), a removable data storage device (e.g., CD/DVD drive, floppy drive, etc.), an input device (e.g., keyboard, mouse, trackball, etc.), an output device (e.g., monitor or display), and an I/O device (e.g., modem, infra-red transmitter/receiver, radio (cellular) transmitter receiver, etc.). It is known to a person skilled in the art that a computer may comprise some or all of those components, in addition to components not listed.

The terms “communicate”, “transmit” and “receive” (and variations thereof) are used herein to refer to the exchange of data within a single computer (e.g., between and among any of a script, an application, a control, etc.), and/or to the uni-directional or bi-directional exchange of data between one or more computers.

While the present invention and the disclosure provided herein is primarily directed to music as the content, other content is also contemplated by and within the scope and spirit of the present invention. For example, the present invention may utilize MIDI content, which directs a MIDI playback device via hardware and/or software. The present invention may also utilize video/animation content.

It will be obvious to persons skilled in the art that the functionality of a computing device such as, for example, a server, is determined in large part by the software which controls the server processor. Thus, a description herein of a plurality of servers providing a plurality of functionality may also be embodied as a single server providing a plurality of functionality. Conversely, a description herein of a single server providing a plurality of or a specific functionality may be embodied as a plurality of servers providing a plurality of or a specific functionality.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A method of communicating content between a first computing device and a second computing device comprising the steps of:
communicating software code to the first computing device; and
communicating a musical composition to the first computing device;
wherein the software code is operable in connection with a processor of the first computing device for:
providing an interface;
enabling a user of the first computing device to manipulate the musical composition and create a user manipulated musical composition;
enabling the user of the first computing device to create a new musical composition; and
enabling the first computing device to communicate a user musical composition to the second computing device.

2. A method as recited by claim 1, wherein the user musical composition comprises one of the musical composition, the user manipulated musical composition, and the new musical composition.

3. A method as recited by claim 1, wherein the software code is operable in connection with the processor of the first computing device for enabling the first computing device to communicate the user musical composition to the second computing device via e-mail, instant messaging, or chat.

4. A method as recited by claim 3, further comprising the steps of:
receiving an e-mail message from the software code, the e-mail message identifying a recipient and including the user musical composition; and
communicating the e-mail message and user musical composition to the recipient.

5. A method as recited by claim 1, further comprising the steps of:
receiving a request from the software code for a musical sample; and
communicating the requested musical sample to the first computing device.

6. A method as recited by claim 1, further comprising the steps of:
receiving a request from the user software code to save the user musical composition; and
causing the user musical composition to be saved on a data storage device of a computing device.

7. A method as recited by claim 6, wherein the computing device is one of the first computing device and a server.

8. A method as recited by claim 1, further comprising the steps of:
receiving a request from the software code to communicate a previously saved musical composition to the first computing device; and
causing the previously saved musical composition to be communicated to the first computing device.

9. A method as recited by claim 1, wherein the musical composition comprises a musical track, and wherein the software code is further operable in connection with the processor of the first computing device for enabling the user to change a parameter of the musical track.

10. A method as recited by claim 1, wherein the musical composition comprises a plurality of musical tracks and wherein the software code is further operable in connection with the processor of the first computing device for enabling the user to change a parameter of each of the plurality of musical tracks.

11. A method as recited by claim 9, wherein the musical composition further comprises an identifier for a musical sample.

12. A method as recited by claim 10, wherein the musical composition further comprises a plurality of identifiers for each of the plurality of musical samples.

13. A method as recited by claim 1, wherein the musical composition includes a plurality of musical tracks, each of the plurality of musical tracks comprising an identifier for a musical sample, and wherein the software code is further operable in connection with the processor of the first computing device for enabling the user to manipulate the musical composition by one of changing a parameter of each of the plurality of musical tracks and changing a musical sample of each of the plurality of musical tracks.

14. A method as recited by claim 11, wherein the identifier for the musical sample is a network location of the musical sample.

15. A method as recited by claim 12, wherein each of the plurality of identifiers is a network location of each of the plurality of musical samples.

16. A method as recited by claim 1, wherein the software code is an applet.

17. A method as recited by claim 16, wherein the applet is operable in connection with one of a Shockwave plug-in and a Flash plug-in.

18. A method as recited by claim 1, wherein the software code is further operable in connection with the processor of the first computing device for enabling the first computing device to communicate a copy of the software code and a user musical composition to the second computing device via e-mail.

19. A system for communicating content between a first and second computing device, said system comprising:
a server having a processor and a data storage device having special purpose software installed thereon, said special purpose software being operable in connection with said processor for:
communicating software code to a first computing device;
communicating a musical composition to the first computing device;
wherein the software code is operable in connection with a processor of the first computing device for:
providing an interface;
enabling a user of the first computing device to manipulate the musical composition and create a user manipulated musical composition;
enabling the user of the first computing device to create a new musical composition; and
enabling the first computing device to communicate a user musical composition to the second computing device.

20. A system as recited by claim 19, wherein said special purpose software is further operable in connection with said processor for:
receiving a request from the software code for a musical sample; and
communicating the requested musical sample.

21. A system as recited by claim 19, wherein said special purpose software is further operable in connection with said processor for:
receiving a request from the software code to save the musical composition; and
causing the musical composition to be saved on a data storage device of a computing device.

22. A method as recited by claim 21, wherein said computing device is one of said server, the first computing device, and another computing device.

23. A system as recited by claim 19, wherein said special purpose software is further operable in connection with said processor for:
receiving a request from the software code to communicate a previously saved musical composition to the user; and
causing the previously saved musical composition to be communicated.

24. A system as recited by claim 19, wherein the musical composition comprises a musical track, and wherein the software code is further operable in connection with the processor of the first computing device for enabling the user to change a parameter of the musical track.

25. A system as recited by claim 19, wherein the musical composition comprises a plurality of musical tracks and wherein the software code is further operable in connection with the processor of the first computing device for enabling the user to change a parameter of each of the plurality of musical tracks.

26. A system as recited by claim 24, wherein the musical composition further comprises an identifier for musical sample.

27. A system as recited by claim 25, wherein the musical composition further comprises a plurality of identifiers for each of the plurality of musical samples.

28. A system as recited by claim 19, wherein the musical composition comprises a plurality of musical tracks, each of the plurality of musical tracks comprising an identifier for a musical sample, and wherein said special purpose software is further operable in connection with said processor for communicating software code to the first computing device operable in connection with the processor thereof for enabling the user to manipulate the musical composition by one of changing a parameter of each of the plurality of musical tracks and changing a musical sample of each of the plurality of musical tracks.

29. A system as recited by claim 26, wherein the identifier is a network location of the musical sample.

30. A system as recited by claim 27, wherein each of the plurality of identifiers is a network location of each of the plurality of musical samples.

31. A system as recited by claim 19, wherein the software code is an applet.

32. A system as recited by claim 24, wherein the applet is operable in connection with one of a Shockwave plug-in and a Flash plug-in.

33. A system as recited by claim 19, wherein said special purpose software is further operable in connection with said processor for communicating software code to the first computing device operable in connection with the processor thereof for enabling the first computing device to communicate a copy of the software code and a user musical composition to the second computing device via e-mail.

34. A method of communicating content between computing devices comprising the steps of:
by a first computing device, communicating software code and a musical composition to a second computing device, wherein the software code is operable in connection with a processor of the second computing device for:
providing an interface;
enabling a user of the second computing device to manipulate the musical composition and create a user manipulated musical composition;
enabling the user of the second computing device to create a new musical composition; and
enabling the second computing device to communicate a user musical composition to another computing device.

35. A method as recited by claim 34, wherein the user musical composition comprises one of the musical composition, the user manipulated musical composition, and the new musical composition.

36. A method as recited by claim 34, wherein the software code is operable in connection with the processor of the second computing device for enabling the second computing device to communicate the user musical composition to the another computing device via e-mail.

37. A method as recited by claim 34, wherein the musical composition comprises a musical track, and wherein the software code is further operable in connection with the processor of the second computing device for enabling the user to change a parameter of the musical track.

38. A method as recited by claim 34, wherein the musical composition comprises a plurality of musical tracks and wherein the software code is further operable in connection with the processor of the second computing device for enabling the user to change a parameter of each of the plurality of musical tracks.

39. A method as recited by claim 37, wherein the musical composition further comprises an identifier for a musical sample.

40. A method as recited by claim 38, wherein the musical composition further comprises a plurality of identifiers for each of the plurality of musical samples.

41. A method as recited by claim 34, wherein the musical composition comprises a plurality of musical tracks, each of the plurality of musical tracks comprising an identifier for a musical sample, and wherein the software code is further operable in connection with the processor of the second computing device for enabling the user to manipulate the musical composition by one of changing a parameter of each of the plurality of musical tracks and changing a musical sample of each of the plurality of musical tracks.

42. A method as recited by claim 39, wherein the identifier is a network location of the musical sample.

43. A method as recited by claim 40, wherein each of the plurality of identifiers is a network location of each of the plurality of musical samples.

44. A method as recited by claim 34, wherein the software code is an applet.

45. A method as recited by claim 44, wherein the applet is operable in connection with one of a Shockwave plug-in and a Flash plug-in.

46. A method as recited by claim 34, wherein the software code is further operable in connection with the processor of the second computing device for enabling the second computing device to communicate a copy of the software code and a user musical composition to the another computing device via e-mail.

47. A method of adding sound to a text message created by a first user having a first computing device with text messaging software installed thereon and operable in connection therewith, the text message being intended by the first user to be communicated to a recipient having a second computing device with text messaging software installed thereon and operable in connection therewith, said method comprising the step of communicating software code to the first computing device for operation in connection with the text messaging software, the software code enabling the first user to select a sound to be added to the text message by adding an identifier to the text message identifying the sound selected by the first user, wherein when the recipient receives and opens the text message, the identifier causes the second computing to playback the sound added by the first user.

48. A method as recited by claim 47, wherein the software application communicated to the second computing device is a Flash plug-in.

49. A method as recited by claim 47, wherein the software code communicated to the first computing device causes a representation of each sound added by the first user to be stored on the first computing device.

50. A method as recited by claim 47, wherein the text software provides an interface via which the first user may create and communicate the text message, wherein the software code communicated to the first computing device is operable in connection with the text software to cause a sound interface to be displayed as part of the interface, wherein the sound interface enables the user to select and preview a sound.

51. A method as recited by claim 50, wherein the sound interface comprises one of a pulldown menu and a button.

52. A method as recited by claim 47, wherein the sound added by the first user is one of a plurality of predetermined sounds.

53. A method as recited by claim 47, wherein the sound added by the first user is created by the first user.

54. A method as recited by claim 50, wherein the sound interface includes a sponsor identifier.
